(19) United States
(12) Patent Application Publication
(10) Pub. No.: US 2005/0276748 A1
(43) Pub. Date: Dec. 15, 2005

(54) Method for generating hydrogen gas, hydrogen gas production apparatus and energy conversion system

(76) Inventors: Hiroyuki Morioka, Tokyo (JP); Atsuo Yamada, Kanagawa (JP); Go Sudo, Kanagawa (JP); Koji Inomata, Kanagawa (JP); Yuichi Tokita, Kanagawa (JP)

Correspondence Address: BELL, BOYD & LLOYD, LLC, P. O. BOX 1135, CHICAGO, IL, 60690-1135, US

(21) Appl. No.: 10/524,514

(22) PCT Filed: Aug. 22, 2003
(86) PCT No.: PCT/JP03/10632

§ 371 Date: Mar. 28, 2005

(30) Foreign Application Priority Data
Aug. 26, 2002 (JP) 2002-244890

(51) Int. Cl. C01B 3/06

(52) U.S. Cl. 423/658.2; 423/644; 429/57

(57) ABSTRACT

A method for generating hydrogen gas, an apparatus for producing hydrogen gas, and an energy conversion system, which are so designed as to generate hydrogen extremely efficiently without the help of catalyst are provided.

The hydrogen gas is generated by decomposing a metal hydride in a mixture composed of said metal hydride, water, and a second solution which has a pH value lower than that of the aqueous solution of said metal hydride wherein the metal hydride is represented by a formula: α_{z(1-x)}β_{zx}[BH_{y}], where α and β are mutually different elements selected from Groups 1A, 2A, and 2B of the periodic table; and x, y, and z are defined respectively by 0≦x≦1, 3<y<6, and 0<z<3. The hydrogen gas generating apparatus is composed of a first reservoir to store the aqueous solution of the metal hydride, a second reservoir to store a second solution which has a pH value lower than that of said aqueous solution, and a reactor to mix together said aqueous solution and said second solution, thereby generating hydrogen gas. The thus evolved hydrogen gas is converted into electrochemical energy by the energy conversion apparatus.

### CROSS REFERENCES TO RELATED APPLICATIONS

The present application claims priority to Japanese Patent Document No. P2002-244890 filed on Aug. 26, 2002, the disclosure of which is herein incorporated by reference.

### TECHNICAL FIELD

The present invention relates to a method for generating hydrogen gas, an apparatus for producing hydrogen gas, and an energy conversion system.

### BACKGROUND ART

Since the Industrial Revolution, fossil fuels such as gasoline and light oil have come into general use as the power source for automobiles, electric power generation, and others in many branches of industry. Use of fossil fuels has greatly contributed to the development of industry which in turn has improved the living standard of human being.

On the other side of the coin, the earth is facing a serious environmental disruption. Moreover, there is a widespread skepticism about the long-term stable supply of fossil fuels.

Under these circumstances, hydrogen fuel is attracting attention as a clean energy source that will replace fossil fuels. This is because hydrogen fuel emits nothing but water after combustion. Considerable attention has been devoted to the development of a new material capable of efficient storage and evolution of hydrogen and easy transportation.

It has recently been reported that NaAlH₄ undergoes reversible hydrogenation and dehydrogenation at about 150° C. in the presence of a catalyst metal such as Ti and Zr, as shown below.
(Journal of Alloys and Compounds, 253-254 (1997), 1-9; and Published Japanese Translation of PCT international publication for patent application No. Hei-11-510133)

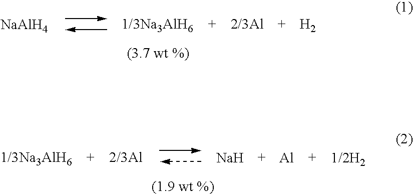

Unfortunately, the hydrogenation and dehydrogenation of NaAlH₄ represented by equation (1) above rapidly decreases in reaction rate as the temperature falls. In other words, NaAlH₄ does not function as a practical hydrogen occludent at temperatures lower than 100° C.

The reaction represented by equation (1) above is accelerated with the aid of a catalyst and the theoretical amount of hydrogen that is released is 3.7 wt %. However, the actual amount of hydrogen that can be used is about 3 wt %, which is not satisfactory.

On the other hand, there has been proposed a method for generating a very large amount of hydrogen by direct reaction between a metal hydride (such as NaH and MgH₂) and water. (This reaction is not reversible.) Hydrogen generation in this manner requires a large amount of labor and cost for safety because the reaction is too vigorous to adequately control.

There has been proposed a technology to get around problems with controllability and safety. This technology permits hydrogen to evolve at normal temperature under normal pressure by stabilizing a hydride (such as NaBH₄ and KBH₄) in an alkaline aqueous solution and bringing it into contact with a catalytic metal. (Japanese Patent Laid-open No. 2002-19401 and International Laid-open No. 01/51410) According to this technology, it is possible to generate as much hydrogen gas as necessary at any time whenever the catalyst is brought into contact with the aqueous solution. The reaction involved in this technology also yields hydrogen from water according to equation (3) below.
NaBH₄+2H₂O→4H₂+NaBO₂+300 kJ/mol (3)
Unfortunately, generation of hydrogen gas by decomposition of BH₄⁻ and H₂O molecules involves a rapid volume change which produces a shock wave to strip off the catalyst. For protection from the shock wave, the catalyst should be supported in a special way. An adequate mode of catalyst supporting is important also for high reaction rates desired, but it is troublesome and expensive.

The reaction for hydrogen generation proceeds only at the interface where the liquid fuel comes into contact with the solid catalyst. Therefore, the rate of reaction is determined by the active specific surface area of the catalyst. Even though the above-mentioned problem with catalyst supporting is solved and the best mode of catalyst supporting is established, there still remains a problem with the selection of a highly active catalyst. Moreover, the catalyst should be previously loaded in a slightly excessive amount in anticipation of the maximum hydrogen generation per unit time. Operation in this manner wastes most of the catalyst when the system is run to generate a small amount of hydrogen. This is undesirable for the effective use of the system's space. Increasing the amount of catalyst and catalyst support makes the system to increase in volume and weight.

In addition, the catalyst is subject to poisoning and deactivation by various reactants. Some reactants mechanically cover the catalyst surface, and others chemically cause deactivation. It is almost impossible to remove such reactants completely from the liquid fuel. This make the system less reliable in its repeated and long-term operation.

There is another problem that the reaction gives rise to NaBO₂ (as a reaction product) which increases in concentration and reduces the reaction efficiency as the reaction proceeds. NaBO₂ not only changes the chemical properties of the solution and separates out on the catalyst surface as its concentration exceeds saturation, but also separates out in the pipe to cause clogging.

The intrinsic defect of the reaction system mentioned above is attributable to the fact that the solution composition changes as the reaction proceeds. It restricts the choice of the initial composition of solution and prevents the continuous use of the solution of ideal composition.

Another problem involved in the reaction system mentioned above is that hydrogen is generated directly from an alkaline aqueous solution and hence the generated hydrogen gas is inevitably contaminated with mist containing impurities such as sodium hydroxide. Such contaminants not only restrict the selection of the constituent materials of the reaction system but also deteriorates the characteristic properties of the reaction system.

The present invention was completed to address the above-mentioned problems. It is an object of the present invention to provide a method for generating hydrogen gas, an apparatus for producing hydrogen gas, and an energy conversion system, which are so designed as to work without inhomogeneous catalytic reactions at the solid-liquid interface, to generate hydrogen extremely efficiently without the help of catalyst, and to retain high reliability throughout repeated and long-term operations.

### DISCLOSURE OF THE INVENTION

The present invention is directed to a method for generating hydrogen gas which comprises decomposing a metal hydride represented by the formula (1) below in a mixture composed of said metal hydride, water, and a second solution which has a pH value lower than that of the aqueous solution of said metal hydride.
α_{z(1-x)}β_{zx}[BH_{y}] Formula (1)
(where α and β are mutually different elements selected from Groups 1A, 2A, and 2B of the periodic table; and x, y, and z are defined respectively by 0≦x≦1, 3<y<6, and 0<z<3.)

The present invention is directed also to an apparatus for producing hydrogen gas which comprises a first reservoir for storage of an aqueous solution of a metal hydride represented by the formula (1) above, a second reservoir for storage of a second solution which has a pH value lower than that of the aqueous solution of said metal hydride, and a reactor to mix together the aqueous solution of said metal hydride and said second solution, thereby generating hydrogen gas.

The present invention is directed also to an energy conversion system which comprises a hydrogen gas generating apparatus and an energy converting apparatus to convert the hydrogen gas produced by said hydrogen gas generating apparatus into electrochemical energy, said hydrogen as generating apparatus having a first reservoir for storage of an aqueous solution of a metal hydride represented by the formula (1) above, a second reservoir for storage of a second solution which has a pH value lower than that of the aqueous solution of said metal hydride, and a reactor to mix together the aqueous solution of said metal hydride and said second solution, thereby generating hydrogen gas.

According to the present invention, a metal hydride represented by the formula (1) above is decomposed in a mixture composed of said metal hydride, water, and a second solution which has a pH value lower than that of the aqueous solution of said metal hydride. Decomposition in this manner is a homogenous liquid-phase reaction that takes place between the aqueous solution and the second solution. Such a homogenous reaction provides much more reaction active sites than the conventional catalytic reaction between a solid catalyst and a liquid fuel. Hence it generates hydrogen gas efficiently.

The homogenous reaction between the aqueous solution and the second solution is stoichiometrically determined unlike the conventional catalyst-assisted reaction. Therefore, it produces hydrogen gas highly efficiently without the help of catalyst so long as the aqueous solution of the metal hydride and the second solution are supplied in a constant ratio according to the theoretical reaction equation and the stage of supply is adequately switched.

In addition, the homogeneous reaction between the aqueous solution of the metal hydride and the second solution which has a lower pH value than said aqueous solution generates hydrogen gas efficiently without the help of catalyst. This contributes to improved reliability in the repeated and continuous operation.

### BRIEF DESCRIPTION OF THE DRAWINGS

FIG. 1 is a schematic diagram showing one example of the apparatus for producing hydrogen gas according to the embodiment of the present invention.

FIG. 2 is a schematic diagram showing another example of the apparatus for producing hydrogen gas according to the embodiment of the present invention.

FIG. 3 is a schematic diagram showing the reservoirs constituting the apparatus for producing hydrogen gas according to the embodiment of the present invention.

FIG. 4 is a schematic diagram showing another example of the apparatus for producing hydrogen gas according to the embodiment of the present invention.

FIGS. 5A and 5B are schematic diagrams each showing another example of the apparatus for producing hydrogen gas according to the embodiment of the present invention.

FIGS. 6A to 6D are schematic diagrams each showing the reactor constituting the apparatus for producing hydrogen gas according to the embodiment of the present invention.

FIGS. 7A and 7B are schematic sectional views each showing the apparatus for producing hydrogen gas according to the embodiment of the present invention.

FIG. 8 is a schematic sectional view showing the fuel cell constituting the energy conversion system according to the embodiment of the present invention.

FIGS. 9A to 9C are schematic sectional view each showing the fuel cell constituting the energy conversion system according to the embodiment of the present invention.

FIG. 10 is a graph showing the change with time of the amount of hydrogen gas generated in the example of the present invention.

FIG. 11 is a graph showing the change with time of the amount of hydrogen gas generated in the example of the present invention.

### BEST MODE FOR CARRYING OUT THE INVENTION

In using the method for generating hydrogen gas according to the present invention, it is desirable to incorporate an aqueous solution of the metal hydride represented by the formula (1) above with a second solution which has a pH value lower than that of the aqueous solution of the metal hydride. It is also desirable to continuously mix for reaction the aqueous solution of the metal hydride with the second solution at a constant ratio.

It is also desirable that the aqueous solution of the metal hydride have a pH value higher than 7, and the second solution have a pH value lower than 7.

In other words, the method for generating hydrogen gas according to the present invention is characterized in that an alkaline aqueous solution of the metal hydride represented by the formula (1) above undergoes homogenous reaction in the presence of an acidic aqueous solution as the second solution, thereby generating hydrogen gas.

The present inventors are the first to find that the above-mentioned problem involved in the conventional technology is solved effectively by mixing together for reaction two aqueous solutions at a constant ratio, one being an alkaline aqueous solution of the metal hydride represented by the formula (1) above and the other being an acidic aqueous solution as the second solution mentioned above.

The fact that the metal hydride represented by the formula (1) is stable in an alkaline aqueous solution reminded the present inventors of an idea that the alkaline aqueous solution of the metal hydride would readily evolve hydrogen gas when it is given dropwise an acidic aqueous solution as the second solution. In addition, the fact that the liquid-liquid reaction is homogeneous suggests that the reaction between the two solutions provides much more active sites than the conventional solid-liquid reaction, thereby evolving hydrogen gas more efficiently.

In view of the fact that the liquid-liquid reaction is stoichiometrically determined unlike the conventional catalyst-assisted reaction, the present inventors conceived of a new method for producing hydrogen gas efficiently without loss under strict controls even in the absence of catalyst by supplying the two solutions at a constant ratio according the theoretical chemical equation and mixing them and adequately switching the stage of supply.

The present inventors experimentally proved the above-mentioned ideas and completed the present invention based on the result.

The metal hydride represented by the formula (1) above contains two kinds of metals denoted by α and β. They are elements selected from Groups 1A, 2A, and 2B of the periodic table. To be concrete, they should preferably be elements selected from Li, Na, K, Mg, Ca, and Zn.

Any metal hydride can be used so long as it is the one represented by the formula (1) above. Among preferred examples are NaBH₄, KBH₄, LiBH₄, Mg(BH₄)₂, Zn(BH₄)₂, and Ca(BH₄)₂, which are rich with hydrogen and highly stable. They may be used alone or in combination with one another. NaBH₄ is particularly preferable because of its low price and its ability to evolve a large amount of hydrogen gas (which is 10.6 wt % based on simple substance and 10.8 wt % based on a mixture with water).

The second solution include inorganic acids (such as hydrochloric acid, sulfuric acid, and phosphoric acid) and organic acids (such as formic acid, acetic acid, and oxalic acid), which may be used as such or in the form of aqueous solution. (Solid acids are invariably used in the form of aqueous solution.) These acids may be used alone or in combination with one another.

Generation of hydrogen gas by the method according to the present invention may be accomplished under any conditions without specific restrictions. However, the reaction temperature should preferably be from −40° C. to 200° C., more preferably from −40° C. to 100° C. With reaction temperatures lower than −40° C., the aqueous solution of the metal hydride freezes to decrease the efficiency of hydrogen generation.

The embodiments of the present invention will be described in more detail with reference to the accompanying drawings.

### Embodiment 1

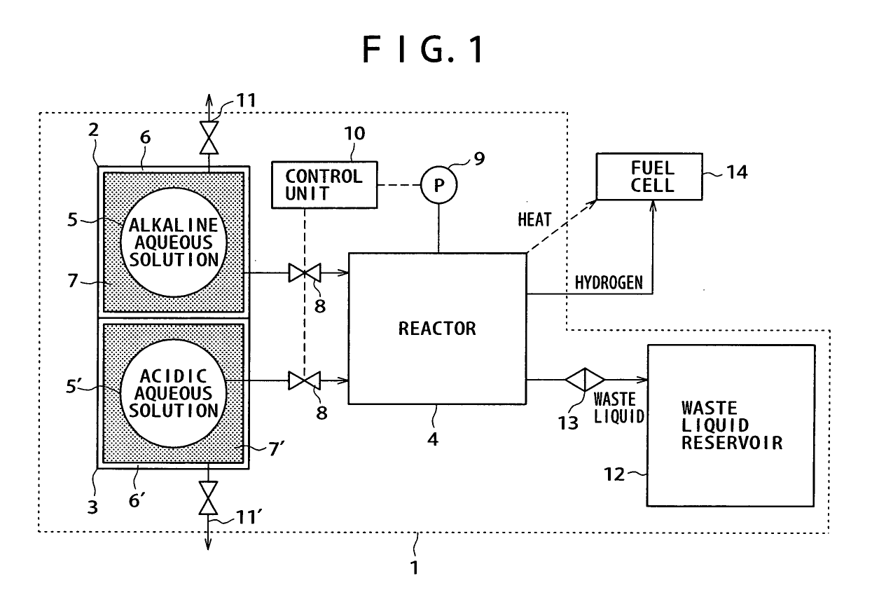

FIG. 1 is a schematic diagram showing the apparatus for producing hydrogen gas according to the present invention.

As shown in FIG. 1, the apparatus 1 for producing hydrogen gas according to the present invention consists of a first reservoir 2 to store the alkaline aqueous solution of the metal hydride, a second reservoir 3 to store the acidic aqueous solution as the second solution, and a reactor 4 in which the alkaline aqueous solution and the acidic aqueous solution are mixed together for reaction to evolve hydrogen gas. The first reservoir 2 and the second reservoir 3 are connected to the reactor 4.

There are flow regulators 8 between the first and second reservoirs 2 and 3 and the reactor 4. The reactor 4 is provided with a pressure sensor 9 to detect flow rates and a control unit 10 to control the flow regulators 8 in response to pressures detected by the pressure sensor 9.

The apparatus 1 for producing hydrogen gas gets the alkaline aqueous solution of the metal hydride and the acidic aqueous solution as the second solution supplied respectively from the first and second reservoirs 2 and 3 to the reactor 4 continuously at a constant ratio determined by the regulators 8. The two solutions are mixed together in the reactor 4 for reaction to evolve hydrogen gas.

The apparatus 1 for producing hydrogen gas according to the present invention effectively functions irrespective of the direction and angle of its installation. Therefore, the first and second reservoirs 2 and 3 should preferably be constructed such that they are filled completely at all times with the alkaline aqueous solution of the metal hydride and the acidic aqueous solution, respectively.

This object is achieved by making each reservoir in dual structure. That is, the first reservoir 2 is provided with an inner container 5 (made of an alkali-resistant flexible material such as rubber) to hold the alkaline aqueous solution. The second reservoir 3 is also provided with an inner container 5′ (made of an acid-resistant flexible material such as rubber) to hold the acidic aqueous solution. These inner containers 5 and 5′ made of a flexible material such as rubber remain completely filled at all times. Moreover, they withstand even when the apparatus itself moves in any direction.

Examples of the flexible material include natural rubber, isoprene rubber, styrene/butadiene rubber, butadiene rubber, ethylene/propylene rubber, chloroprene rubber, acrylonitrile/butadiene rubber, acrylic rubber, urethane rubber, and polysulfide rubber.

The first reservoir 2 has its inner container 5 installed in an alkali-resistant outer container 6. The second reservoir 3 has its inner container 5′ installed in an acid-resistant outer container 6′. The outer containers 6 and 6′ contribute to improved shock resistance.

The first reservoir 2 holds a substance 7, which cures upon reaction with the alkaline aqueous solution, in the space between the inner container 5 and the outer container 6. The second reservoir 3 holds a substance 7′, which cures upon reaction with the acidic aqueous solution, in the space between the inner container 5′ and the outer container 6′. This structure ensures safety when the alkaline aqueous solution or the acidic aqueous solution leaks out from the inner container.

Examples of the substance that reacts with the alkaline aqueous solution include α-olefin resin adhesive and alkali-curable acrylic emulsion.

Examples of the substance that reacts with the acidic aqueous solution include rubber cement, acid-curable furan resin, acid-curable furan-phenolic resin, acid-curable phenolic resin, acid-curable vinyl acetate emulsion, and acid-curable aminoalkyl resin.

The first and second reservoirs 2 and 3 are provided with safety valves 11 and 11′, respectively, so that their internal pressure is kept below a certain value. As shown in FIG. 1, the safety valves 11 and 11′ are installed such that they receive the pressure in the opposite directions. This structure contributes to improved safety.

The apparatus also has a waste liquid reservoir 12 to store waste liquid discharged from the reactor 4. The pipe to introduce waste liquid into the waste liquid reservoir 12 should preferably be provided with a check valve 13.

The apparatus 1 for producing hydrogen gas, which is constructed as mentioned above, offers the advantage that a homogeneous reaction takes place between the alkaline aqueous solution of the metal hydride and the acidic solution as the second solution. This homogenous reaction provides much more reaction active sites than the conventional catalytic reaction that takes place between the solid catalyst and the solid fuel. The result is the efficient hydrogen evolution.

Moreover, the homogenous reaction between the alkaline aqueous solution and the acidic aqueous solution is stoichiometrically determined unlike the conventional catalyst-assisted reaction. Therefore, the apparatus according to the present invention produces hydrogen gas highly efficiently without the help of catalyst so long as the alkaline aqueous solution of the metal hydride and the acidic aqueous solution as the second solution are supplied in a constant ratio according to the theoretical reaction equation and the stage of supply is adequately switched.

Owing to the liquid phase homogenous reaction, the apparatus according to the present invention can produce hydrogen gas efficiently without the help of catalyst, which contributes to improved reliability in repeated and long-term operations.

The apparatus 1 for producing hydrogen gas may be combined with a fuel cell 14, as mentioned later. In this case, it is desirable that the fuel cell 14 be supplied with hydrogen gas introduced from the reactor 4. An alternative constitution would be possible in which the fuel cell 14 is supplied with heat generated by the reactor 4.

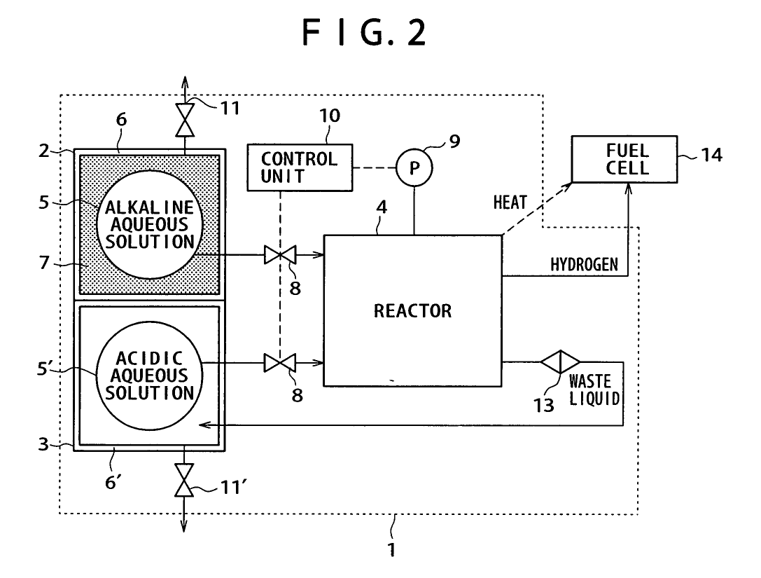

The embodiment mentioned above is concerned with the apparatus provided with the waste liquid reservoir 12 to store waste liquid discharged from the reactor 4. However, there is an alternative as shown in FIG. 2. Its constitution differs from the original one in that the waste liquid is introduced into the space between the inner container (5 and/or 5′) and the outer container (6 and/or 6′) in place of the waste liquid reservoir. The space is not filled with the substance 7 and/or 7′, as a matter of course. This constitution obviates the necessity of separately installing the waste liquid reservoir 12, which permits the size reduction of the apparatus. Incidentally, it is desirable that a check value 13 be placed in the pipe to introduce waste liquid into the space between the inner container (5 and/or 5′) and the outer container (6 and/or 6′).

### Embodiment 2

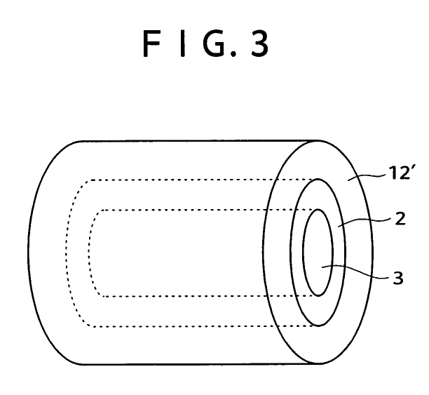

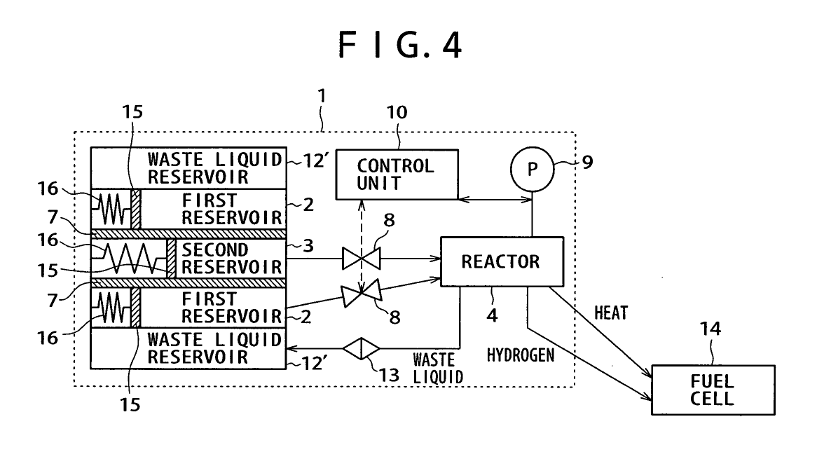

The apparatus for producing hydrogen gas according to Embodiment 2 of the present invention is shown in FIGS. 3 and 4. It is has the first reservoir 2 to store the alkaline aqueous solution of the metal hydride and the second reservoir 3 to store the acidic aqueous solution as the second solution, which are of concentric dual (or multiple) pipe structure. The reservoirs 2 and 3 may be connected to the reactor 4. In this case, the waste liquid reservoir 12′ is installed concentrically on the outside of the second reservoir 2 as shown in FIGS. 3 and 4, although it may be separately installed as shown in FIG. 1.

A syringe-type structure may be applied to the first reservoir 2, the second reservoir 3, and the waste liquid reservoir 12′. In this case, the first and second reservoirs 2 and 3 are provided with the movable walls 15 to push out the alkaline aqueous solution and the acidic aqueous solution. The movable wall 15 is energized into one direction by an elastic means 16 (such as spring). In other words, it works as a piston. The piston action continuously pushes out the alkaline aqueous solution of the metal hydride and the acidic aqueous solution as the second solution.

Between the first and second reservoirs 2 and 3 and the reactor 4 are the flow regulators 8, which are controlled by the control unit 10 connected to the pressure sensor 9 to detect the internal pressure of the reactor 4.

The apparatus 1 for producing hydrogen gas according to Embodiment 2 of the present invention is constructed such that the alkaline aqueous solution of the metal hydride (which is stored in the first reservoir 2) and the acidic aqueous solution as the second solution (which is stored in the second reservoir 3) are continuously supplied to the reactor 4 at a constant ratio (under control of regulators 8) by the movable walls 15 which are actuated by the elastic means 16 (such as spring), and the two aqueous solutions are mixed together for reaction to evolve hydrogen gas.

The adoption of the syringe-type structure for the first and second reservoirs 2 and 3 and the waste liquid reservoir 12′ permits the first and second reservoirs 2 and 3 to be completely filled with the alkaline aqueous solution and the acidic aqueous solution, respectively, at all times.

It is desirable that the space between the first reservoir 2 and the second reservoir 3 be filled with a substance 7 (such as gel-like substance) which cures upon reaction with the alkaline solution and/or the acidic solution.

The apparatus 1 for producing hydrogen gas as mentioned above generates hydrogen gas by liquid phase homogenous reaction between the alkaline aqueous solution of the metal hydride represented by the formula (1) above and the acidic aqueous solution as the second solution. Therefore, it produces the same effect as Embodiment 1 mentioned above.

### Embodiment 3

The method for generating hydrogen gas according to the present invention is based on the liquid phase reaction. The hydrogen gas produced in this way may entrain droplets (or mist) of the aqueous solution. Such entrainment not only restricts the selection of the materials for the apparatus but also deteriorates the characteristic properties.

Therefore, it is desirable that the apparatus 1 for producing hydrogen gas according to the present invention be modified such that the reactor 4 is provided with a mechanism to separate hydrogen gas alone.

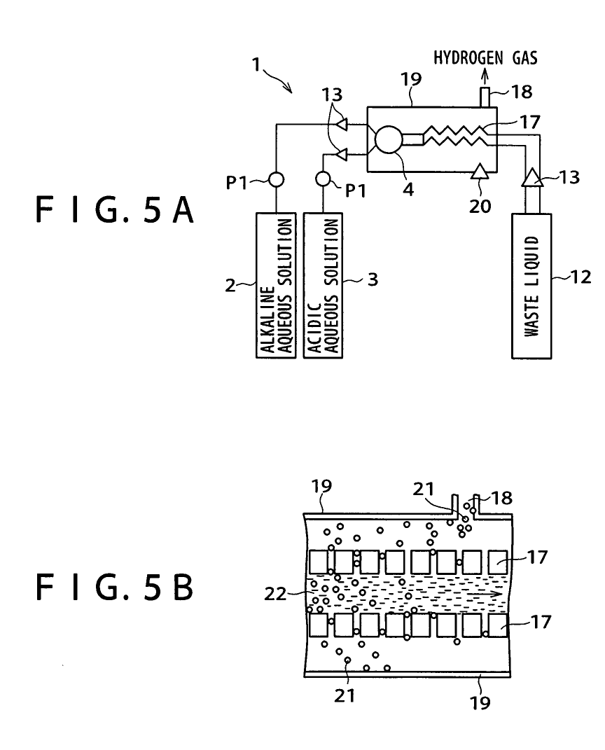

That is, it is desirable that the reactor 4 be connected to a porous pipe 17 which is permeable to hydrogen gas but impermeable to liquid, as shown in FIGS. 5A and 5B. In this case, the reaction to evolve hydrogen gas takes place in the reactor 4 and/or the porous pipe 17, so that the evolved hydrogen gas 21 and the mixture 22 (composed of the waste liquid and the unreacted alkaline and acidic aqueous solutions) pass through the porous pipe 17, and the hydrogen gas 21 alone permeates through the porous pipe 17. In this way the hydrogen gas 21 continuously separates from the mixture 22. Incidentally, the supply pumps P1 are resistant to the alkaline and acidic aqueous solutions.

Hydrogen gas (whose molecules are the smallest among all gases) readily permeates through the porous pipe 17, as shown in FIG. 5B. Introduction of the evolved hydrogen gas 21 and the mixture 22 (composed of the waste liquid and the unreacted alkaline and acidic aqueous solutions) into the porous pipe 17 in the direction of the arrow raises the internal pressure in the porous pipe 17, producing a pressure difference. This pressure difference discharges the hydrogen gas 21 from the porous pipe 17, leaving the mixture 22 therein.

It is desirable that the reactor 4 and the porous pipe 17 be installed in a sealed container 19 which is impermeable to hydrogen gas and which has a hydrogen gas outlet 18. This structure permits the continuous recovery of the hydrogen gas 21 discharged from the porous pipe 17. The recovered hydrogen gas 21 is discharged from the sealed container 19 through the hydrogen gas outlet 18.

The above-mentioned structure permits the hydrogen gas 21 to be discharged naturally owing to difference between the atmospheric pressure and the internal pressure in the porous pipe 17 which rises as hydrogen gas is evolved. Consequently, the apparatus 1 for producing hydrogen gas can be run at the atmospheric pressure without the help of external power supply to operate an evacuating unit (such as vacuum pump). This is the difference from the conventional apparatus which needs evacuation to remove dissolved gas from the liquid.

The porous pipe 17 should preferably be formed from an acid- and alkali-resistant material, such as porous polyethylene, polypropylene, polycarbonate, and perfluoropolyethylene resins, with the last one being most desirable. Moreover, the porous pipe 17 should preferably be water-repellent so that it prevents clogging with the mixture 22.

The porous pipe 17 should preferably take on a spiral form, with at least one turn, in the sealed container 19. The porous pipe 17 in spiral form permits the evolved hydrogen gas 21 and the mixture 22 to move smoothly therein regardless of the position in which the apparatus 1 for producing hydrogen gas operates. It also permits the hydrogen gas 21 to be separated and recovered efficiently.

It is also desirable that the sealed container 19 holding the porous pipe 17 be equipped with a valve 20 that opens when the internal pressure of the container exceeds a certain limit. The method for generating hydrogen gas according to the present invention is based on the phase change from liquid to gas, and hence it involves a steep pressure increase in the container. The valve 20 opens the container and protects the apparatus from damage in case of unforeseeable rapid pressure increase.

### Embodiment 4

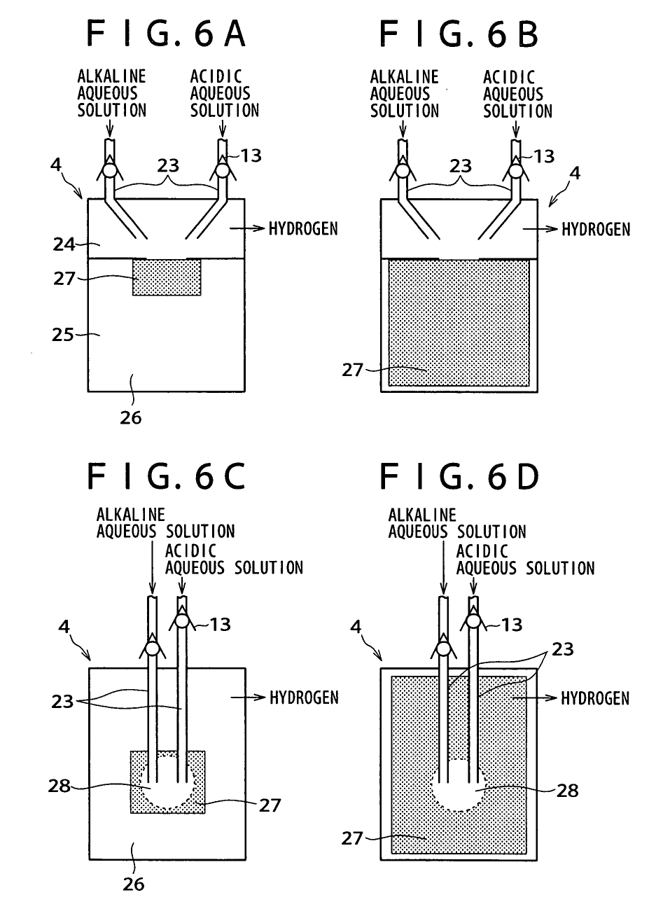

The apparatus 1 for producing hydrogen gas according to the present invention has the reactor 4, the schematic sectional views of which are shown in FIGS. 6A to 6D.

The reactor 4 may be comprised of the liquid receiving compartment 24 and the water absorbent holding compartment 25, which communicate with each other. The latter compartment may be filled with a moisture absorbent 26.

The liquid receiving compartment 24 is supplied with the alkaline aqueous solution of the metal hydride mentioned above and the acidic aqueous solution as the second solution through the feeding pipes 23 equipped with the check valves 13. These two aqueous solutions react with each other to evolve hydrogen gas, leaving waste liquid and unreacted solutions. The waste liquid and unreacted solutions are absorbed by the water absorbent (or moisture absorbent) 26 held in the water absorbent holding compartment 25. The evolved hydrogen gas is discharged by any means (not shown) from the liquid receiving compartment 24. As the evolution of hydrogen gas proceeds, the water absorbed portion 27 of the water absorbent 25 increases, as shown in FIG. 6A (before reaction) and FIG. 6B (after reaction).

Because of this structure, the apparatus 1 for producing hydrogen gas according to the present invention does not need the reservoir for waste liquid. This allows the size reduction of the apparatus.

The above-mentioned structure may be modified as shown in FIGS. 6C and 6D. In this case, a space 28 is formed in the water absorbent holding compartment 25 filled with the moisture absorbent 26 (or in the reactor 4). This space 28 is supplied with the alkaline aqueous solution and the acidic aqueous solutions through the feeding pipes 23 (equipped with check valves 13) which pass through the water absorbent holding compartment 25 or the reactor 4.

Examples of the moisture absorbent 26 include starch-polyacrylonitrile hydrolyzate, cross-linked starch-polyacrylate, cross-linked carboxymethylcellulose, saponified product of vinyl acetate-methyl acrylate copolymer, and cross-linked sodium acrylate.

### Embodiment 5

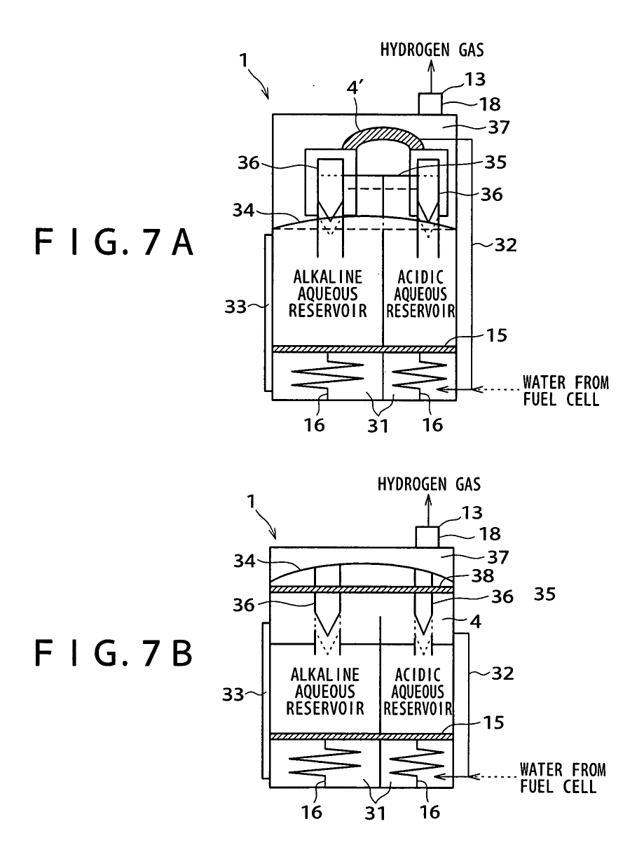

The apparatus 1 for producing hydrogen gas according to the present invention may be modified further as shown in FIGS. 7A and 7B, which are schematic sectional views.

The method for generating hydrogen gas according to the present invention requires that the alkaline aqueous solution and the acidic aqueous solution be mixed together and reacted with each other continuously at a constant stoichiometric ratio. The supply stage of the two aqueous solutions should be adequately switched for efficient production of highly controlled hydrogen gas without loss.

The apparatus for producing hydrogen gas should preferably be equipped with a mechanism to keep constant the flow rate (and hence the mixing ratio) of the alkaline aqueous solution and the acidic aqueous solution. A simple, efficient method is to optimize the conductance ratio of the feeing pipe. To be concrete, it is desirable that the feeding pipes differ from each other in diameter, as shown in FIGS. 7A and 7B. An alternative is to attach resistors (such as holes) at prescribed positions in the feeding pipe between the first and second reservoirs and the reactor. It is possible to optimize conductance by properly selecting the size of the resistor.

For stable production of hydrogen gas, it is desirable to replenish the alkaline aqueous solution and the acidic aqueous solution as soon as they are consumed. In other words, it is desirable to provide a regulating function. This regulating function should be able to rapidly feed back the decrease in hydrogen pressure, which occurs as hydrogen gas is discharged from the reactor 4, to the supply of the two aqueous solutions. To be concrete, this object is achieved by mechanically regulating the control valve 36 with a pressure-displacement conversion element (such as diaphragm), in such a way that the total flow rate of the two aqueous solutions is automatically controlled. Incidentally, the pressure-displacement conversion element (such as diaphragm) may be replaced by a liquid pump or the like.

It is desirable that the apparatus 1 for producing hydrogen gas according to the present invention effectively work irrespective of the direction and angle of its installation. Therefore, it is desirable that the first and second reservoirs be constructed such that they are filled with the alkaline aqueous solution and the acidic aqueous solution, respectively, at all times.

This object is achieved by providing the reservoirs with movable walls 15 which push out the alkaline aqueous solution and the acidic aqueous solution, respectively, as shown in FIGS. 7A and 7B.

The movable wall 15 is energized in one direction by an elastic means 16 (such as spring) attached to one side thereof. The energized movable walls 15 push the alkaline aqueous solution and the acid aqueous solution to the reactor 4 (or 4′) continuously.

The space to accommodate the elastic means 16 (such as spring) should preferably be able to store the waste liquid discharged from the reactor 4 (or 4′) and water discharged from the device (such as fuel cell) connected to the apparatus 1 for producing hydrogen gas. In this way it is possible to reduce further the size of the apparatus.

The movable wall 15 continuously moves as the aqueous solutions are consumed. Therefore, the reservoirs may be constructed such that the position of the movable wall 15 is visible from outside, or the amount of aqueous solutions remaining in the reservoirs is read by the indicator 33.

The apparatus 1 for producing hydrogen gas as shown in FIG. 7A has the movable wall 15 which is energized in one direction by an elastic means 16 (such as spring) attached to one side thereof. The energized movable wall 15 continuously pushes the alkaline and acidic aqueous solutions to the reactor 4′.

The reactor 4′ has a gas-liquid separating membrane. The hydrogen gas evolved in the reactor 4′ permeates through the gas-liquid separating membrane, so that it is stored in the primary hydrogen reservoir 37 equipped with a check valve 13 and a hydrogen gas outlet 18. The hydrogen gas may be discharged from the primary hydrogen reservoir 37 and the apparatus 1 at any time.

The waste liquid that occurs in the reactor 4′ is introduced into the space 31 (to accommodate the elastic means 16 such as spring) through the waste liquid return pipe 32.

The reservoirs of the alkaline and acidic aqueous solutions are equipped with the diaphragm 34 as a pressure-displacement conversion element. The diaphragm 34 is connected to the supply control valve 36 through a link 35, so that it mechanically regulates the supply control valve 36. The pressure decrease that occurs as hydrogen gas permeates through the gas-liquid separating membrane and leaves from the reactor 4′is fed back to the supply of the two aqueous solutions without delay. In this way it is possible to automatically control the total flow rate of the alkaline aqueous solution and the acidic aqueous solution.

While the alkaline aqueous solution and the acidic aqueous solution are being supplied, the diaphragm 34 and the control valve rest at the position indicated by the solid line. When the supply of the two aqueous solutions are suspended, the diaphragm 35 moves to the position indicated by the dotted line, and the control valve 36 also moves to the position indicated by the dotted line because it is connected to the diaphragm 35 by the link 35. Thus the control valves close the supply pipes for the two aqueous solutions, and the supply of the two aqueous solutions is suspended.

The apparatus 1 for producing hydrogen gas as shown in FIG. 7B is similar in structure to that shown in FIG. 7A. The only difference is that the reactor 4′ and the gas-liquid separating membrane are installed separately.

The apparatus for producing hydrogen gas according to the present invention, which is shown in FIGS. 7A and 7B, permits a series of processes including mixing, reaction, and waste disposal to be accomplished efficiently under better control. Moreover, it can be made small in size and it works irrespective of the direction of installation.

### Embodiment 6

The apparatus for producing hydrogen gas according to the present invention is applicable to a variety of electrochemical devices. An example of such electrochemical devices is one which is comprised of a first electrode, a second electrode, and a proton (H⁺) conductor held between the two electrodes. The first electrode is supplied hydrogen gas from the apparatus for producing hydrogen gas according to the present invention, and the second electrode is supplied with oxygen or an oxygen-containing gas. The electrochemical device constructed in this manner generates electric power satisfactorily on account of efficient hydrogen gas supply.

Examples of the proton conductor include Nafion (in general use) and fullerene derivatives of fullerenol (such as fullerene polyhydroxide). The proton conductor based on a fullerene derivative is described in International Patent Laid-open No. 01/06519.

The fullerene derivative as the proton conductor may be used alone or in combination with a binder.

A description is given below of a fuel cell which consists of the apparatus for producing hydrogen gas according to the present invention and the electrochemical device having a proton conductor composed substantially of the fullerene derivative alone. The proton conductor may be in the form of pressure-molded film.

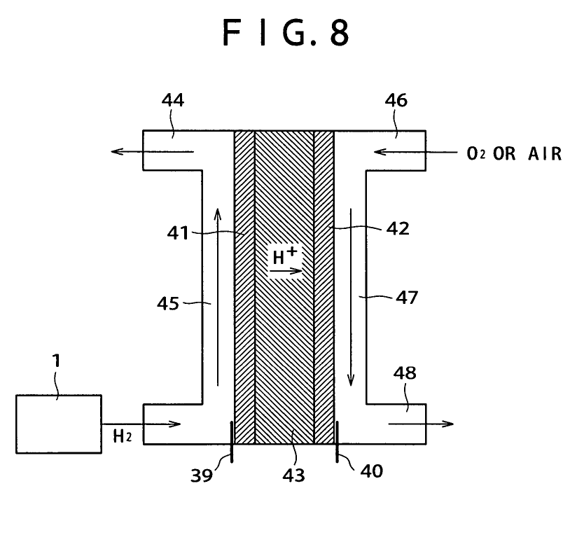

FIG. 8 shows the electrochemical device used as the fuel cell. The fuel cell is comprised of an anode (fuel electrode or hydrogen electrode) 41, a cathode (oxygen electrode) 42, and a proton conductor 43 held between the two electrodes. The two electrodes facing each other have terminals 39 and 40, respectively. They also have a catalyst attached to or dispersed therein. During operation, the anode 41 is supplied with hydrogen from the apparatus 1 for producing hydrogen gas according to the present invention. Unreacted hydrogen is discharged from the exhaust port 44 (which may be omitted). During its flow through the passage 45, the fuel (H₂) generates protons. These protons, together with protons which have evolved in the proton conductor 43, migrate toward the cathode 42. Then these protons react with oxygen (air) flowing through the passage 47 from the inlet 46 to the outlet 48. This reaction produces electromotive force as desired.

The fuel cell mentioned above is supplied with hydrogen gas continuously and stably from the apparatus 1 for producing hydrogen gas according to the present invention. Therefore, it generates electric power with good output characteristics.

The advantage of this fuel cell is a high hydrogen ion conductivity, which arises from the fact that dissociation of hydrogen ions takes place in the anode 41 and hydrogen ions (supplied from the anode 41) migrate toward the cathode 42 while dissociation of hydrogen ions is also taking place in the proton conductor 43. This mode of reaction does not need a humidifier unlike the conventional system which employs Nafion as the proton conductor. This simplifies the structure of the system and reduces the weight of the apparatus. Another advantage is that the fuel cell has improved functions, such as high current density and good output characteristics.

In the above-mentioned fuel cell, the proton conductor held between the first and second electrodes is a fullerene derivative in the form of pressure-molded film; however, the proton conductor may be replaced by a fullerene derivative incorporated with a binder. The proton conductor of this type has a sufficient strength due to bonding by a binder.

The binder used for the proton conductor may be selected from polyfluoroethylene, polyvinylidene fluoride, polyvinyl alcohol, etc. capable of film forming. They may be used alone or in combination with one another. The amount of the binder in the proton conductor should be no more than 20 wt %. With an amount in excess of 20 wt %, it would decrease the conductivity of hydrogen ions.

The proton conductor containing a binder exhibits the same proton conductor as that composed substantially of a fullerene derivative alone.

Moreover, the proton conductor containing a binder has better film-forming properties owing to the binder (which is a polymeric material). Therefore, it gives a flexible gas-impermeable ion conducting film which is stronger and thinner (300 μm or less) than that formed from a powder of fullerene derivative by compression molding.

The proton conducting thin film can be formed from the fullerene derivative containing a binder by any known film-forming method, such as compression molding and extrusion molding.

The proton conductor used in the above-mentioned electrochemical device is not specifically restricted. Any material can be used so long as it has the ion (hydrogen ion) conductivity. It includes fullerene derivatives (such as fullerene hydroxide and fullerene sulfate ester) and Nafion.

### Embodiment 7

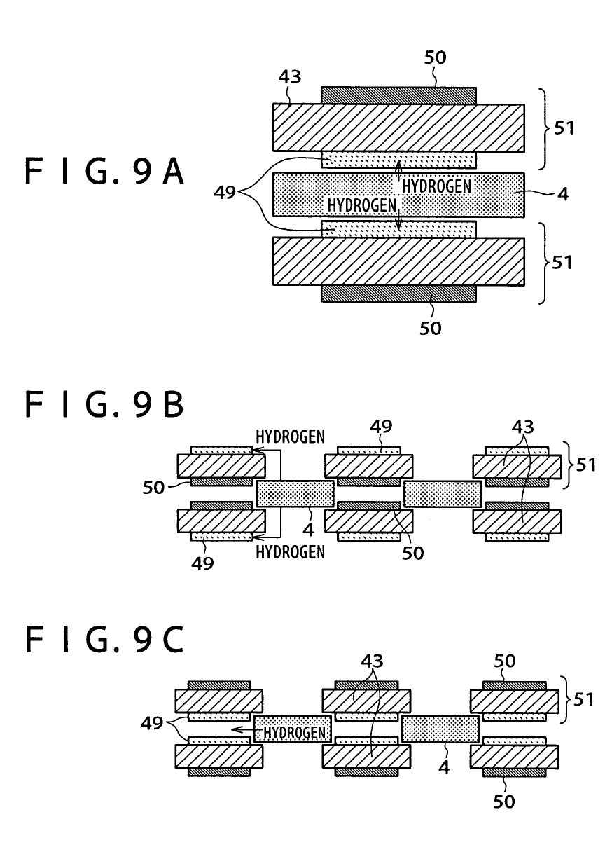

The energy conversion system according to the present invention is shown in FIGS. 9A to 9C. It differs in structure from that shown in FIG. 8. It may be constructed such that the reactor is united with the electrochemical energy conversion means of the above-mentioned energy conversion apparatus. The term “electrochemical energy conversion means” denotes the MEA (membrane & electroassembly) film which is comprised of a hydrogen electrode with a catalyst (such as platinum), an ion (proton) conductor, and an oxygen electrode with a catalyst (such as platinum).

FIG. 9A is a schematic diagram showing an important part of the energy conversion system according to the present invention. The energy conversion system is comprised of a pair of electrochemical energy conversion means (MEA film) 51 and a reactor 4 held between them.

FIG. 9B shows another version of the energy conversion system which is constructed such that the oxygen electrode 50 of the MEA film 51 is placed inside and the hydrogen electrode 49 of the MEA film 51 is placed outside, and hydrogen gas evolved by the reactor 4 is supplied to the hydrogen electrode 49.

FIG. 9C shows further another version of the energy conversion system which is constructed such that the hydrogen electrode 49 of the MEA film 51 is placed inside, and hydrogen gas evolved by the reactor 4 is supplied to the hydrogen electrode 49. In this case, hydrogen gas can be supplied to the hydrogen electrode 49 more efficiently. Moreover, the oxygen electrode 50 of the MEA film 51, which is placed outside, facilitates the disposal of water occurring in the oxygen electrode 50.

The structure shown in FIGS. 9A to 9C permits hydrogen gas and heat (which are evolved by the reactor 4) to be supplied more efficiently to the energy conversion device mentioned above. The energy supply in this manner obviates the need for providing the energy conversion device with a heater. This contributes to further size reduction.

The energy conversion system according to the present invention may be arranged in an electrically driven device such as vehicles, radios, and telephones. This holds true particularly in the case where the energy conversion device functions as a fuel cell.

### EXAMPLES

The invention will be described in more detail with reference to the following examples, which are not intended to restrict the scope thereof.

### Example 1

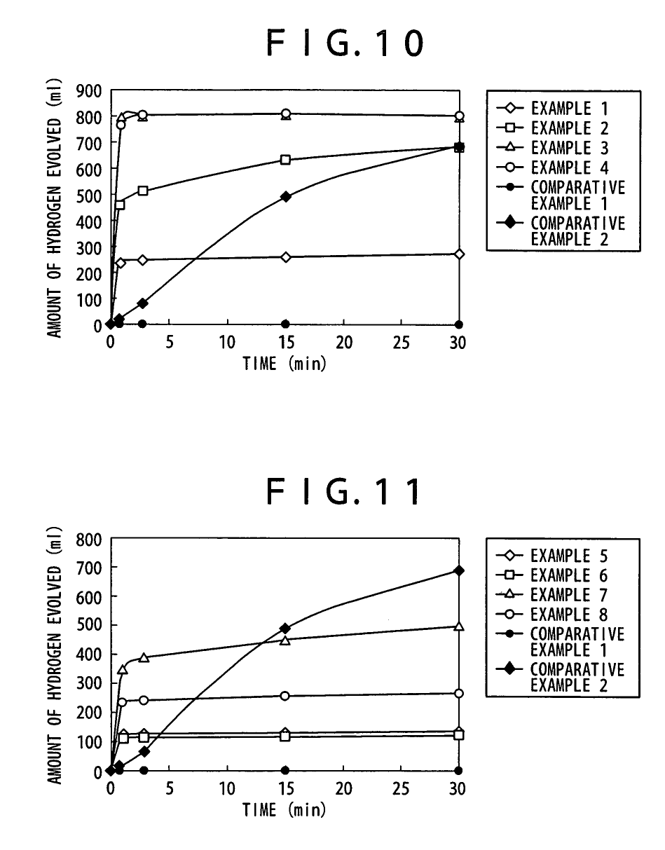

An alkaline aqueous solution composed of 1 wt % of NaBH₄, 1 wt % of NaOH, and 98 wt % of H₂O was prepared as follows. First, NaOH (with a purity higher than 96%, from Wako Junyaku) was dissolved in water, and then NaBH₄ (with a purity higher than 95%, from Wako Junyaku) was dissolved in the previously prepared NaOH solution. This alkaline aqueous solution, which has a pH value of 12 or above, was given dropwise 0.5 mL of hydrochloric acid (with a purity of 35-37%, from Wako Junyaku), which has a pH value of 1 or below. The amount of hydrogen evolved with the lapse of time was measured. The evolved hydrogen was collected by replacement of water. The relation between the amount of hydrogen evolved and the elapsed time is shown in FIG. 10.

### Example 2

The same procedure as in Example 1 was repeated except that the hydrochloric acid was replaced by acetic acid (with a purity of 99.7%, pH≦1, from Wako Junyaku). The results are shown in FIG. 10.

### Example 3

The same procedure as in Example 1 was repeated except that the hydrochloric acid was replaced by sulfuric acid (with a purity of 95%, pH≦1, from Kokusan Kagaku). The results are shown in FIG. 10.

### Example 4

The same procedure as in Example 1 was repeated except that the hydrochloric acid was replaced by phosphoric acid (with a purity of 95%, pH≦1, from Kokusan Kagaku). The results are shown in FIG. 10.

### Comparative Example 1

The same procedure as in Example 1 was repeated except that the hydrochloric acid was replaced by pure water. The results are shown in FIGS. 10 and 11.

### Comparative Example 2

An experiment was carried out on the evolution of hydrogen gas from an alkaline aqueous solution of NaBH₄ according to a known method that employs a Ru catalyst available from Millennium Cell. The Ru catalyst was prepared according to the thesis published in “International Journal of Hydrogen Energy 25 (2000) 969-975”. The alkaline aqueous solution of NaBH₄ has the same concentration as that used in Examples. The amount of hydrogen gas evolved from 30 mL of the alkaline aqueous solution was measured against time. The results are shown in FIGS. 10 and 11.

It is apparent from FIG. 10 that the amount of hydrogen evolved varies depending on the kind of the acid used. It was also fond that no hydrogen was evolved when the acid was replaced by pure water.

It is also found that the homogeneous reaction between the alkaline aqueous solution of NaBH₄ and the acidic aqueous solution evolves hydrogen gas more rapidly than the reaction with the known Ru catalyst and also evolves as much hydrogen as theoretically contained in NaBH₄ in an extremely short time. By contrast, the reaction with the Ru catalyst merely evolves hydrogen gas in an amount of about 90% of the theoretical value over a long period of time. This proves that the method for producing hydrogen gas according to the present invention is superior to the conventional one.

### Example 5

The same procedure as in Example 1 was repeated except that the amount of hydrochloric acid was changed from 0.5 mL to 0.2 mL. The results are shown in FIG. 11.

### Example 6

The same procedure as in Example 2 was repeated except that the amount of acetic acid was changed from 0.5 mL to 0.2 mL. The results are shown in FIG. 11.

### Example 7

The same procedure as in Example 3 was repeated except that the amount of sulfuric acid was changed from 0.5 mL to 0.2 mL. The results are shown in FIG. 11.

### Example 8

The same procedure as in Example 4 was repeated except that the amount of phosphoric acid was changed from 0.5 mL to 0.2 mL. The results are shown in FIG. 11.

It is apparent from FIG. 11 that the amount of hydrogen evolved by the homogeneous reaction system can be controlled as desired according as the amount of the acidic aqueous solution is changed. It is also apparent that even though the amount of the acidic aqueous solution is reduced, the evolution of hydrogen gas is not delayed in the initial stage. This suggests that the evolution of hydrogen gas in the initial stage with the acidic aqueous solution in a reduced amount is much faster than that with the conventional known catalyst.

It was found that the hydrogen gas evolved is free of alkaline components and the reaction only leaves a neutral solution which is nontoxic, safe, and environmentally friendly.

Exploitation in Industry

As mentioned above, the present invention is designed to evolve hydrogen gas from the metal hydride represented by the formula (1) above by its decomposition in a mixture composed of an alkaline aqueous solution of the metal hydride and an acidic aqueous solution. The reaction between the two aqueous solutions is a homogenous liquid phase reaction which has much more active sites than the conventional catalytic reaction between the liquid fuel and the solid catalyst. Therefore, the method according to the present invention is capable of evolving hydrogen gas efficiently.

In addition, the homogenous reaction between the alkaline aqueous solution and the acidic aqueous solution is determined stoichiometrically unlike the conventional catalyst-assisted reaction. Therefore, it permits efficient evolution of hydrogen gas without the help of catalyst as far as the alkaline aqueous solution and the acidic aqueous solution are fed and mixed in a certain ratio according to the theoretical formula and the supply stage is properly switched. Thus, the method and apparatus of the present invention are capable of producing highly controlled hydrogen gas without any loss.

In addition, the homogeneous reaction between the alkaline aqueous solution and the acidic aqueous solution permits efficient evolution of hydrogen gas without the help of catalyst. Therefore, the method and apparatus according to the present invention are highly reliable in the repeated and long-term operation.

1-49. (canceled)

50. A method for generating hydrogen gas comprising decomposing a metal hydride in a mixture composed of the metal hydride, water, and a second solution which has a pH value lower than an aqueous solution of the metal hydride wherein the metal hydride has a formula:
α_{z(1-x)}β_{zx}[BH_{y}]
where α and β are mutually different elements selected from Groups 1A, 2A, and 2B of the periodic table; and x, y, and z are defined respectively by 0≦x≦1, 3<y<6, and 0<z<3.

51. The method for generating hydrogen gas as defined in claim 50, wherein α and β each represent an element selected from the group consisting of Li, Na, K, Mg, Ca, and Zn.

52. The method for generating hydrogen gas as defined in claim 50, wherein the aqueous solution of the metal hydride is incorporated with a second aqueous solution which has a lower pH value than said aqueous solution of said metal hydride.

53. The method for generating hydrogen gas as defined in claim 50, wherein the aqueous solution of the metal hydride and the second aqueous solution are mixed together for reaction continuously at a constant ratio.

54. The method for generating hydrogen gas as defined in claim 50, wherein the aqueous solution of the metal hydride has a pH value higher than 7 and the second aqueous solution has a pH value lower than 7.

55. The method for generating hydrogen gas as defined in claim 50, wherein the second solution is an acid in a liquid form or an aqueous solution of an acid.

56. The method for generating hydrogen gas as defined in claim 50, wherein the second solution is an acidic aqueous solution of an inorganic acid or an organic acid.

57. An apparatus for producing hydrogen gas comprising: a first reservoir for storage of an aqueous solution of a metal hydride; a second reservoir for storage of a second solution which has a pH value lower than an aqueous solution of the metal hydride; and a reactor to mix together the aqueous solution of the metal hydride and the second solution, thereby generating hydrogen gas wherein the metal hydride has a formula: α_{z(1-x)}β_{zx}[BH_{y}] where α and β are mutually different elements selected from Groups 1A, 2A, and 2B of the periodic table; and x, y, and z are defined respectively by 0≦x≦1, 3<y<6, and 0<z<3.

58. The apparatus for producing hydrogen gas as defined in claim 57, wherein α and β each represent an element selected from the group consisting of Li, Na, K, Mg, Ca, and Zn.

59. The apparatus for producing hydrogen gas as defined in claim 57, wherein the aqueous solution of the metal hydride has a pH value higher than 7 and the second aqueous solution has a pH value lower than 7.

60. The apparatus for producing hydrogen gas as defined in claim 57, wherein the second solution is an acid in a liquid form or an aqueous solution of an acid.

61. The apparatus for producing hydrogen gas as defined in claim 57, wherein the second solution is an acidic aqueous solution of an inorganic acid or an organic acid.

62. The apparatus for producing hydrogen gas as defined in claim 57, wherein the first reservoir and the second reservoir each is connected to the reactor.

63. The apparatus for producing hydrogen gas as defined in claim 57, which has a mechanism by which the aqueous solution of the metal hydride and the second aqueous solution are mixed together for reaction continuously at a constant ratio.

64. The apparatus for producing hydrogen gas as defined in claim 57, wherein the first reservoir and the second reservoir are constructed such that they are completely filled at all times with the aqueous solution of the metal hydride and the second solution.

65. The apparatus for producing hydrogen gas as defined in claim 64, wherein the first reservoir has an aqueous solution container which is made of an alkali-resistant flexible material and the second reservoir has a liquid container made of an acid-resistant flexible material.

66. The apparatus for producing hydrogen gas as defined in claim 65, wherein the internal container as the aqueous solution container of the first reservoir is installed in an alkali-resistant external container, and the internal container as the liquid container is installed in an acid-resistant external container.

67. The apparatus for producing hydrogen gas as defined in claim 66, wherein the space between the internal container of the first reservoir and the external container is filled with a substance which cures upon reaction with the alkaline aqueous solution, and the space between the internal container of the second reservoir and the external container is filled with a substance which cures upon reaction with the acidic aqueous solution.

68. The apparatus for producing hydrogen gas as defined in claim 57, which has a flow regulator placed between the reactor and at least one of the first reservoir and the second reservoir.

69. The apparatus for producing hydrogen gas as defined in claim 68, which has a pressure sensor to detect an internal pressure of the reactor and a controller to regulate the action of the regulator in response to a value detected by the pressure sensor.

70. The apparatus for producing hydrogen gas as defined in claim 57, wherein the hydrogen gas is discharged from the reactor.

71. The apparatus for producing hydrogen gas as defined in claim 57, wherein the first reservoir and the second reservoir each has a safety valve to maintain the internal pressure below a prescribed value.

72. The apparatus for producing hydrogen gas as defined in claim 71, wherein the safety valve for the first reservoir and the safety valve for the second reservoir are installed such that the gas pressure is applied in a mutually opposite direction.

73. The apparatus for producing hydrogen gas as defined in claim 57, which has a waste liquid reservoir to store waste liquid discharged from the reactor.

74. The apparatus for producing hydrogen gas as defined in claim 57, wherein the waste liquid that has occurred in the reactor is introduced into and stored in the space between the external container and the internal container of the first reservoir and/or the second reservoir.

75. The apparatus for producing hydrogen gas as defined in claim 57, wherein the first reservoir and the second reservoir include any one of concentric dual-pipe and multi-pipe structure connected to the reactor.

76. The apparatus for producing hydrogen gas as defined in claim 75, wherein the pipe structure to store the waste liquid from the reactor includes any one concentric dual-pipe and multi-pipe structure.

77. The apparatus for producing hydrogen gas as defined in claim 75, wherein the space between the first reservoir and the second reservoir is filled with a substance which cures upon reaction with the alkaline aqueous solution and/or the acidic aqueous solution.

78. The apparatus for producing hydrogen gas as defined in claim 57, wherein the reactor is provided with a mechanism to separate hydrogen gas.

79. The apparatus for producing hydrogen gas as defined in claim 78, wherein the reactor is connected to a porous pipe which is permeable to hydrogen gas and impermeable to liquid, the reaction to evolve hydrogen gas takes place in the reactor and/or the porous pipe, and the mixture of the evolved hydrogen gas and the aqueous solution passes through the porous pipe so that only hydrogen gas permeates through the porous pipe and the hydrogen gas is separated from the aqueous solution.

80. The apparatus for producing hydrogen gas as defined in claim 57, wherein the reactor is composed of a liquid introducing part and a water-absorbent part connected thereto, and the aqueous solution of the metal hydride and the second solution are introduced into the liquid introducing part for reaction, and the aqueous solution is absorbed by the water-absorbent part.

81. The apparatus for producing hydrogen gas as defined in claim 80, wherein the liquid introducing part and the water-absorbent part are adjacent to each other.

82. The apparatus for producing hydrogen gas as defined in claim 80, wherein the water-absorbent part has a space formed therein, and the aqueous solution of the metal hydride and the second solution are supplied to the space through the water-absorbent part.

83. The apparatus for producing hydrogen gas as defined in claim 57, which has a control mechanism to regulate the flow rate of the aqueous solution of the metal hydride and the second solution which are supplied to the reactor.

84. The apparatus for producing hydrogen gas as defined in claim 83, wherein the pipe to supply the aqueous solution of the metal hydride to the reactor and the pipe to supply the second solution to the reactor differ in diameter from each other.

85. The apparatus for producing hydrogen gas as defined in claim 83, wherein the control mechanism has a pressure-displacement conversion element.

86. The apparatus for producing hydrogen gas as defined in claim 85, wherein the control mechanism is a pressure-displacement conversion element of diaphragm type.

87. The apparatus for producing hydrogen gas as defined in claim 57, wherein the containers for the aqueous solution of the metal hydride and the second solution each has a movable wall in contact with the inside thereof to push out any one of the aqueous solution or the second solution.

88. The apparatus for producing hydrogen gas as defined in claim 87, wherein the movable wall is energized in one direction by an elastic means attached to one side thereof so that any one of the aqueous solution or the second solution is continuously pushed out.

89. The apparatus for producing hydrogen gas as defined in claim 87, wherein the movable wall constitutes a piston of a syringe.

90. The apparatus for producing hydrogen gas as defined in claim 89, wherein the waste liquid discharged from the reactor is stored in the space which accommodates the elastic means.

91. An energy conversion system comprising a hydrogen gas generating apparatus and an energy converting apparatus to convert the hydrogen gas produced by said hydrogen gas generating apparatus into electrochemical energy, said hydrogen gas generating apparatus having a first reservoir for storage of an aqueous solution of a metal hydride, a second reservoir for storage of a second solution which has a pH value lower than that of the aqueous solution of said metal hydride, and a reactor to mix together the aqueous solution of said metal hydride and said second solution, thereby generating hydrogen gas wherein the metal hydride has a formula:
α_{z(1-x)}β_{zx}[BH_{y}]
where α and β are mutually different elements selected from Groups 1A, 2A, and 2B of the periodic table; and x, y, and z are defined respectively by 0≦x≦1, 3<y<6, and 0<z<3.

92. The energy conversion system as defined in claim 91, wherein α and β each represent an element selected from the group consisting of lithium, sodium, potassium, magnesium, calcium, and zinc.

93. The energy conversion system as defined in claim 91, which has a mechanism to supply heat evolved by the reactor to the energy conversion apparatus.

94. The energy conversion system as defined in claim 91, which has a mechanism to supply water evolved by the energy conversion apparatus to the hydrogen gas generating apparatus.

95. The energy conversion system as defined in claim 91, wherein the energy conversion apparatus is united with the reactor.

96. The energy conversion system as defined in claim 91, wherein the energy conversion apparatus is a fuel cell.

97. The energy conversion system as defined in claim 91, wherein an electrochemical energy conversion means composed of a hydrogen electrode, an ion conductor, and an oxygen electrode is connected to the reactor.

98. The energy conversion system as defined in claim 97, wherein the reactor is held between a pair of the electrochemical energy conversion means.
